(19) United States
(12) Patent Application Publication
(10) Pub. No.: US 2013/0075009 A1
(43) Pub. Date: Mar. 28, 2013

(54) ALL-STEEL TIRE

(71) Applicant: Tatsuya MIYAZAKI, Kobe-shi (JP)

(72) Inventor: Tatsuya MIYAZAKI, Kobe-shi (JP)

(21) Appl. No.: 13/616,211

(22) Filed: Sep. 14, 2012

(30) Foreign Application Priority Data
Sep. 22, 2011 (JP) 2011-207881

(51) Int. Cl. B60C 9/18; B60C 9/02

(52) U.S. Cl. 152/537

(57) ABSTRACT

Provided is an all-steel tire including an insulation which achieves excellent adhesion to cords, sheet processability, fuel economy, and elongation at break, as well as high durability for preventing a separation between carcass cords and rubber, and the like. The present invention relates to an all-steel tire including an insulation produced from a rubber composition which includes: a diene rubber, a wet silica with a BET specific surface area of 70-250 m²/g, a carbon black with a BET specific surface area of 30-90 m²/g, and sulfur, an amount of the wet silica being 7-20 parts by mass, an amount of the carbon black being 30-60 parts by mass, an amount of the sulfur being 3.0-5.6 parts by mass, and an amount of an organic acid cobalt being not more than 0.08 parts by mass in terms of cobalt, all for each 100 parts by mass of the diene rubber.

### TECHNICAL FIELD

The present invention relates to an all-steel tire (tire (pneumatic tire) with steel belts and a steel carcass) which includes an insulation (tie gum) containing specific components.

### BACKGROUND ART

Many pneumatic radial tires for heavy load vehicles such as trucks and buses have an all-steel radial construction in which steel cords are used for both carcass cords serving as a framework of the tire, and cords of belt layers located radially outward of the carcass cords and inside of the tread. Such all-steel tires generally have excellent tire strength. However, open threads (excessive rubber flow of an insulation) may occur in the buttress or clinch portion during vulcanization, and in severe cases, rubber may be peeled off carcass cords when a car is driving on the road.

More specifically, in a tire for trucks and buses with a carcass in which steel cords are topped with rubber as shown in FIG. 1, for example, waves as shown in FIG. 2 are likely to be formed by the rubber flow of the insulation during vulcanization. Then, the waves can grow by driving, which may cause an initial crack or separation between the carcass cords and topping rubber (FIG. 3).

Meanwhile, the insulation is required to have good sheet processability, fuel economy, and elongation at break, in addition to high durability for preventing a separation. Additionally, the insulation is also required to have good adhesion to steel cords in case the insulation rubber contacts with the carcass cords, for example, when the cutting of the carcass has not been carried out properly. However, a tire satisfying all these properties has not been given. For example, Patent Literature 1 discloses a rubber composition for an insulation including bituminous coal, silica, and a specific silane coupling agent, in which the fuel economy, durability, and the like are improved in a balanced manner. However, this rubber composition still leaves something to be desired in terms of improving all the properties mentioned above.

### CITATION LIST

Patent Literature

Patent Literature 1: JP 2011-132358 A

### SUMMARY OF INVENTION

Technical Problem

The present invention aims to solve the above problems and provide an all-steel tire with an insulation which is excellent in adhesion to cords, sheet processability, fuel economy, and elongation at break, as well as high durability for preventing a separation between carcass cords and rubber, and the like.

Solution to Problem

The present invention relates to a tire with steel belts and a steel carcass (all-steel tire) which includes an insulation produced from a rubber composition, the rubber composition including a diene rubber, a wet silica with a BET specific surface area of 70 to 250 m²/g, a carbon black with a BET specific surface area of 30 to 90 m²/g, and sulfur, an amount of the wet silica being 7 to 20 parts by mass, an amount of the carbon black being 30 to 60 parts by mass, an amount of the sulfur being 3.0 to 5.6 parts by mass, and an amount of an organic acid cobalt being not more than 0.08 parts by mass in terms of cobalt, all for each 100 parts by mass of the diene rubber.

The rubber composition preferably has a Mooney viscosity ML₍₁₊₄₎ of 54 to 72 at 130° C. when the rubber composition is at an initial stage of vulcanization.

Preferably, the rubber composition includes a vulcanization accelerator, the amount of the carbon black with a BET specific surface area of 30 to 90 m²/g is 40 to 55 parts by mass, and the amount of the vulcanization accelerator is 0.7 to 2.0 parts by mass, all for each 100 parts by mass of the diene rubber.

### ADVANTAGEOUS EFFECTS OF INVENTION

The present invention provides an all-steel tire including an insulation produced from a rubber composition which includes predetermined amounts of a diene rubber, a wet silica with a BET specific surface area of 70 to 250 m²/g, a carbon black with a BET specific surface area of 30 to 90 m²/g, and sulfur; and has an organic acid cobalt content of a predetermined amount or less. Therefore, in the adjacent .carcass, an initial crack and separation between rubber and carcass cords can be prevented, which allows the tire to have excellent durability. Also, the rubber composition forming an insulation, which contains the above components, can achieve excellent adhesion to cords, excellent sheet processability, excellent fuel economy, and excellent elongation at break.

### BRIEF DESCRIPTION OF DRAWINGS

FIG. 1 shows a schematic cross-sectional view of the right half of a pneumatic tire for trucks and buses.

FIG. 2 shows a schematic cross-sectional view of a joining area of the carcass, insulation, and inner liner of the tire shown in FIG. 1 after vulcanization.

FIG. 3 shows a schematic cross-sectional view of a joining area of the carcass, insulation, and inner liner of the tire shown in FIG. 1 after driving.

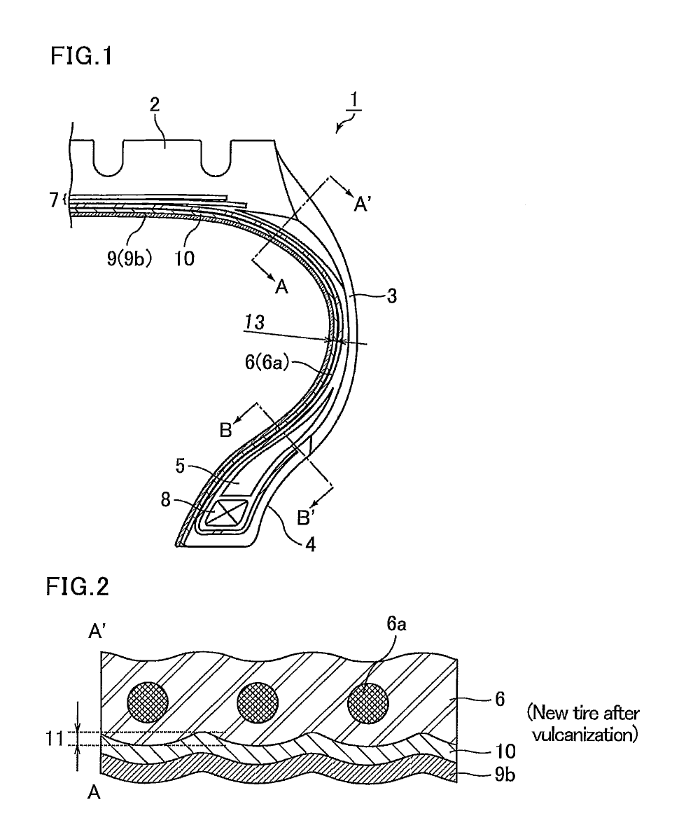

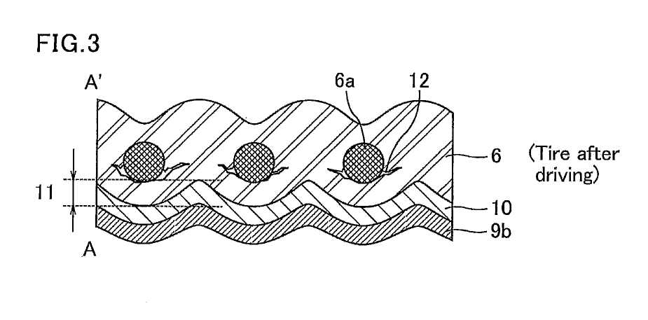

### DESCRIPTION OF EMBODIMENTS

The all-steel tire of the present invention includes an insulation produced from a rubber composition including predetermined amounts of a diene rubber, a wet silica with a BET specific surface area of 70 to 250 m²/g, a carbon black with a BET specific surface area of 30 to 90 m²/g, and sulfur; and having an organic acid cobalt content of a predetermined amount or less.

In all-steel tires used for vehicles such as trucks and buses whose tires are subjected to high internal pressure during use, the air pressure or the heat generated during use usually promotes rubber flow between the cords. To address this, in the present invention, a specific amount of the wet silica is added to an insulation rubber containing predetermined amounts of a diene rubber, a specific carbon black, and sulfur. Therefore, the viscosity of a kneaded rubber composition for an insulation can be kept high, which reduces the rubber flow during vulcanization. Thus, a tire can be produced in which an initial crack and a separation can be prevented and excellent durability can be achieved.

Further, addition of the specific amount of the wet silica contributes to improvement of the elongation at break, and moreover, to achievement of good fuel economy and sheet processability. This addition also contributes to enhancement of the adhesion to cords, thereby making it possible to reduce the amount of an organic acid cobalt and to ensure the adhesion with an organic acid cobalt content of a predetermined amount or less. Since silica is lately becoming less expensive than carbon black, the use of wet silica also contributes to cost reduction. Therefore, an all-steel tire can be provided which is excellent not only in durability but also in adhesion to cords, sheet processability, fuel economy, and elongation at break.

In the all-steel tire according to the present invention, the diene rubber used for the rubber composition forming an insulation (rubber composition for an insulation) is not particularly limited, and examples thereof include natural rubber (NR), butadiene rubber (BR), styrene-butadiene rubber (SBR), isoprene rubber (IR), ethylene-propylene-diene rubber (EPDM), and acrylonitrile-butadiene rubber (NBR). One of these may be used alone, and two or more of these may be used in combination. Among these, NR and/or IR are preferably used, or a combination of BR with NR and/or IR is preferably used, in terms of balanced performance of durability, adhesion to cords, sheet processability, fuel economy, and elongation at break. In the rubber composition, usable NR is not particularly limited, and examples thereof include those generally used in the tire industry such as SIR20, RSS#3, and TSR20. The IR is not particularly limited, either, and known products may be used.

In the case where the rubber composition includes NR, the total amount of NR and IR is preferably not less than 50 mass %, and more preferably not less than 65 mass %, based on 100 mass % of the rubber component. If the total amount of NR and IR is less than 50 mass %, sufficient tensile strength is less likely to be secured and the above balanced performance tends to be deteriorated. The upper limit of the amount of NR is not particularly limited.

In the case where the rubber composition includes BR, the amount of BR is preferably not less than 5 mass %, and more preferably not less than 15 mass %, based on 100 mass % of the rubber component. The amount of BR below 5 mass % tends not to exhibit a unique merit of BR, which is improvement of crack growth resistance. The amount of BR is preferably not more than 40 mass %, and more preferably not more than 25 mass %, based on 100 mass % of the rubber component. The amount of BR exceeding 40 mass % tends to result in deterioration of processability and elongation at break.

Use of the wet silica with a specific BET specific surface area in the present invention can keep a high viscosity, and accordingly achieve excellent durability and excellent sheet processability. In addition, good adhesion to cords, good fuel economy, and good elongation at break can be achieved.

The BET specific surface area (N₂SA) of wet silica is not less than 70 m²/g, preferably not less than 80 m²/g, and more preferably not less than 90 m²/g. If the N₂SA is below 70 m²/g, the viscosity tends to be low and the effect of improving adhesion tends not to be sufficiently achieved. Also, the BET specific surface area is not more than 250 m²/g, preferably not more than 230 m²/g, and more preferably not more than 210 m²/g. If the N₂SA exceeds 250 m²/g, the silica is less likely to be dispersed and the processability may be deteriorated.

The BET specific surface area of wet silica can be determined by the BET method in accordance with ASTM D3037-93.

The amount of the wet silica is not less than 7 parts by mass, and preferably not less than 10 parts by mass, for each 100 parts by mass of the diene rubber. If the amount of the wet silica is below 7 parts by mass, the effects of addition of silica, which are improvement in viscosity, adhesion to cords, and elongation at break, and reduction in tan δ, may not be sufficiently achieved. The amount of the silica is not more than 20 parts by mass, and preferably not more than 15 parts by mass, for each 100 parts by mass of the diene rubber. If the amount of the silica exceeds 20 parts by mass, the processability may be deteriorated, and especially non-uniform shrinking of the sheet may become noticeable.

In the present invention, a known silane coupling agent may be used in combination with the silica, such as sulfide silane coupling agents, mercapto silane coupling agents, vinyl silane coupling agents, amino silane coupling agents, glycidoxy silane coupling agents, nitro silane coupling agents, and chloro silane coupling agents. However, the silica can be sufficiently dispersed without such a silane coupling agent.

Therefore, the amount of the silane coupling agent may be not more than 3 parts by mass, or not more than 2 parts by mass, or not more than 1 part by mass, for each 100 parts by mass of silica. The silane coupling agent does not have to be particularly added. This contributes to cost reduction.

The rubber composition includes the carbon black, which gives good reinforcement and achieves good durability, fuel economy, elongation at break, and adhesion to cords in a balanced manner.

The BET specific surface area (N₂SA) of carbon black is not less than 30 m²/g, and preferably not less than 35 m²/g. The N₂SA below 30 m²/g may not achieve sufficient elongation at break. The BET specific surface area is not more than 90 m²/g, preferably not more than 85 m²/g, and more preferably not more than 45 m²/g. The N₂SA exceeding 90 m²/g may adversely affect the heat build-up and the sheet processability.

The BET specific surface area of carbon black can be determined in accordance with JIS K 6217-2:2001.

The amount of the carbon black with a BET specific surface area of 30 to 90 m²/g is not less than 30 parts by mass, and preferably not less than 40 parts by mass, for each 100 parts by mass of the diene rubber. The amount below 30 parts by mass may not give sufficient reinforcement. The amount is not more than 60 parts by mass, and preferably not more than 55 parts by mass, for each 100 parts by mass of the diene rubber. The amount exceeding 60 parts by mass may not result in sufficient fuel economy.

The total amount of carbon black and silica is preferably not less than 37 parts by mass, and more preferably not less than 40 parts by mass, for each 100 parts by mass of the diene rubber. The total amount below 37 parts by mass may not allow sufficient rubber flow, and may not achieve sufficient elongation at break and sufficient E*. The total amount is preferably not more than 80 parts by mass, and more preferably not more than 70 parts by mass, for each 100 parts by mass of the diene rubber. The total amount exceeding 80 parts by mass may not result in sufficient sheet processability and sufficient fuel economy.

A rubber composition for an insulation optionally contains an organic acid cobalt in order to improve the adhesion to steel cords. However, since the rubber composition of the present invention contains the wet silica, sufficient adhesion maybe secured even if the cobalt content is reduced. Examples of the organic acid cobalt mentioned herein include cobalt stearate, cobalt naphthenate, cobalt neodecanoate, cobalt boron 3 neodecanoate, and cobalt abietate.

In the rubber composition, the amount of the organic acid cobalt is, in terms of cobalt, not more than 0.08 parts by mass, preferably not more than 0.07 parts by mass, and more preferably not more than 0.01 parts by mass, for each 100 parts by mass of the diene rubber, or the organic acid cobalt may not be included. In the present invention, the cobalt content can be reduced because the viscosity of the kneaded rubber composition can be kept high, which reduces the rubber flow during vulcanization, thereby making it possible to eliminate almost all chance of contact of the insulation with the cords.

The rubber composition of the present invention includes sulfur. Examples of the sulfur include powdered sulfur, precipitated sulfur, colloidal sulfur, insoluble sulfur, and highly dispersible sulfur.

In the rubber composition, the amount of sulfur is not less than 3.0 parts by mass, and preferably not less than 4.0 parts by mass, for each 100 parts by mass of the diene rubber.

The amount of sulfur below 3.0 parts by mass tends to result in a lack of E* or of the adhesion to cords, and tends to adversely affect tan 5. The amount of sulfur is not more than 5.6 parts by mass, and preferably not more than 5.3 parts by mass, for each 100 parts by mass of the diene rubber. The amount of sulfur exceeding 5.6 parts by mass may deteriorate the sheet processability due to sulfur blooms, and decrease the durability due to thermo-oxidative degradation in the whole of the tie gum, plies, and sidewalls.

Here, the amount of sulfur as used herein refers to the amount of pure sulfur contained in a sulfur vulcanizing agent (s) such as powdered sulfur and insoluble sulfur mentioned above, which is to be included in the rubber composition. Specifically, in the case where oil-containing sulfur is used, the pure sulfur refers to a pure sulfur component of the sulfur used.

The rubber composition may include a stearic acid compound such as stearic acid or cobalt stearate. The amount of the stearic acid component (the amount of stearic acid in the stearic acid compound) is preferably not more than 1.0 part by mass, and more preferably not more than 0.9 parts by mass, for each 100 parts by mass of the diene rubber. If the amount exceeds 1.0 part by mass, the rubber composition tends to be difficult to be adjusted to have a high viscosity, and the adhesion to cords tends to be deteriorated.

The rubber composition may include any compounding agents conventionally used in the rubber industry, such as a vulcanization accelerator, wax, an antioxidant, and an age resister, in addition to the above ingredients.

Examples of the vulcanization accelerator include guanidine compounds, aldehyde-amine compounds, aldehyde-ammonia compounds, thiazole compounds, sulfenamide compounds, thiourea compounds, thiuram compounds, dithiocarbamate compounds, and xanthate compounds. Particularly, in terms of dispersibility into rubber and stability of vulcanizate properties, preferred are sulfenamide vulcanization accelerators [such as N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), and N,N-diisopropyl-2-benzothiazole sulfenamide], N-tert-butyl-2-benzothiazolylsulfenimide (TBSI), and di-2-benzothiazolyldisulfide (DM). In the present invention, since the wet silica improves adhesion, replacement by inexpensive TBBS is possible.

The amount of the vulcanization accelerator is preferably not less than 0.3 parts by mass, and more preferably not less than 0.7 parts by mass, for each 100 parts by mass of the rubber component. Also, the amount is preferably not more than 2.0 parts by mass, and more preferably not more than 1.5 parts by mass. The amount of the vulcanization accelerator within the above range allows favorable crosslink density, E* and adhesion to cords, and thus a rubber composition having desirable properties can be produced.

The rubber composition for an insulation preferably has a Mooney viscosity ML₍₁₊₄₎ of 54 to 72, and more preferably of 56 to 68, at 130° C. when the rubber composition is at an initial stage of vulcanization. The Mooney viscosity within the above range allows controlled rubber flow, which can prevent a crack and a separation. Here, the Mooney viscosity is determined in accordance with JIS K6300.

In the all-steel tire of the present invention which includes the rubber composition for an insulation (insulation rubber layer), the thickness of the insulation layer is preferably in the range of 0.2 to 2.5 mm when the thickness is measured at a maximum width position of the tire loaded with a prescribed internal pressure. If the thickness is not less than 0.2 mm, a favorable effect is obtained on the rubber flow, durability, and processability. If the thickness is not more than 2.5 mm, a favorable effect is obtained on the fuel economy, heat build-up, and weight saving. The lower limit of the thickness of the insulation layer is more preferably not less than 0.6 mm, and the upper limit thereof is more preferably not more than 1.5 mm.

The all-steel tire of the present invention can be produced according to the following method: A rubber composition is prepared from the above various components by a known method, for example, by kneading them with a rubber kneading apparatus such as a Banbury mixer or an open roll mill. The rubber composition is formed into an insulation shape, and then assembled with other tire components to form an unvulcanized tire. Then, the unvulcanized tire is vulcanized to produce an all-steel tire. The all-steel tire is a tire in which steel cords are used for both the carcass and breakers, and is suitably used as a heavy load tire (tires for trucks and buses, tires for industrial vehicles such as heavy machinery, etc.).

### EXAMPLES

Hereinafter, the present invention will be described in more detail based on examples. The examples are not intended to limit the scope of the present invention.

The following are various chemicals used in Examples and Comparative Examples.

NR: TSR20

IR: IR2200 produced by JSR Corporation

BR: VCR617 (SPB-containing BR) produced by Ube Industries, Ltd.

Butyl rubber: Chlorobutyl HT1066 (chlorobutyl rubber) produced by Japan Butyl Co., Ltd.

Carbon black (N762) : Statex N762 (BET: 27 m²/g) produced by Columbian Carbon Company

Carbon black (N660): N660 (BET: 32 m²/g) produced by Jiangxi Black Cat

Carbon black (N550) : SHOBLACK N550 (BET: 40 m²/g) produced by Cabot Japan K. K.

Carbon black (N326) : Diablack LH (BET: 83 m²/g) produced by Mitsubishi Chemical Corporation

Carbon black (N220): SHOBLACK N220 (BET: 111 m²/g) produced by Cabot Japan K. K.

Silica (VN3): Ultrasil VN3 (BET: 175 m²/g) produced by Evonik Degussa Japan Co., Ltd.

Silica (VN2): Ultrasil VN2 (BET: 125 m²/g) produced by Evonik Degussa Japan Co., Ltd.

Silica (U360): U360 (BET: 50 m²/g) produced by Evonik Degussa Japan Co., Ltd.

Silica (Z1085Gr): Z1085Gr (BET: 80 m²/g) produced by Rhodia

Silica (U9000) : U9000 (BET: 230 m²/g) produced by Evonik Degussa Japan Co., Ltd.

C5 resin: Marukarez T-100AS (C5 petroleum resin) produced by Maruzen Petrochemical Co., Ltd.

TDAE oil: Vivatec 500 produced by H & R Group

Silane coupling agent: Si 75 produced by Evonik Degussa Japan Co., Ltd.

Adhesive resin: Sumikanol 620 (modified resorcinol-formaldehyde condensate) produced by Sumitomo Chemical Co., Ltd.

Zinc oxide: Zinc oxide produced by Mitsui Mining and Smelting Co., Ltd.

Stearic acid: “Tsubaki”, stearic acid produced by NOF Corporation

Cobalt boron neodecanoate: DIC NBC-2 (cobalt content: 22.5 mass %) produced by DIC Corporation

Cobalt stearate: Cost-F (cobalt content: 9.5 mass %) produced by DIC Corporation

Antioxidant: Antigene 6C (N-phenyl-N′-(1,3-dimethylbutyl)-p-phenylenediamine) produced by Sumitomo Chemical Co., Ltd.

Oil-containing insoluble sulfur: Crystex HSOT20 (insoluble sulfur containing 80 mass % of sulfur and 20 mass % of oil) produced by Flexsys

Duralink HTS: Duralink HTS (hexamethylene-1,6-bis(thiosulfate), disodium salt, dihydrate) produced by Flexsys

Activator 73A: Activator 73A (mixture of zinc salt of aliphatic carboxylic acid and zinc salt of aromatic carboxylic acid) produced by Struktol Company

Sumikanol 507A: Sumikanol 507A (modified etherified methylol melamine resin (partial condensate of hexamethylol melamine pentamethyl ether (HMMPME)), containing 35 mass % of silica and oil) produced by Sumitomo Chemical Co., Ltd.

Vulcanization accelerator TBBS: Nocceler NS (N-tert-butyl-2-benzothiazolylsulfenamide) produced by Ouchi Shinko Chemical Industrial Co., Ltd. Vulcanization accelerator TBSI: Santocure TBSI

(N-tert-butyl-2-benzothiazolylsulfenimide) produced by Flexsys

Vulcanization accelerator DCBS: Nocceler DZ (N,N′-dicyclohexyl-2-benzothiazolylsulfenamide) produced by Ouchi Shinko Chemical Industrial Co., Ltd.

### EXAMPLES AND COMPARATIVE EXAMPLES

Materials according to each formulation shown in Tables 1 and 2, except for the sulfur and vulcanization accelerator, were kneaded at 150° C. for four minutes with a 1.7-L Banbury mixer to prepare a kneaded mixture. Subsequently, the sulfur and vulcanization accelerator were added to the kneaded mixture, and the resulting mixture was further kneaded at 100° C. for two minutes with an open roll mill to prepare an unvulcanized rubber composition. The prepared unvulcanized rubber composition was press-vulcanized in a 2-mm-thick mold at 150° C. for 35 minutes (conditions for trucks and buses) to produce a vulcanized rubber composition.

Also, the prepared unvulcanized rubber composition was formed into an insulation shape, and was assembled with other tire components to form an unvulcanized tire. The unvulcanized tire was press-vulcanized at 150° C. for 35 minutes to produce an all-steel tire for trucks and buses. The specification of the tire follows below.

(Tire for trucks and buses (TBR))

275/70R22.5

Thickness of insulation: shown in Tables 1 and 2

Inner liner: 100 mass % butyl rubber per total rubber component

Carcass: steel cords (for general purpose); total thickness of cords and topping rubber: 1.80 mm; cord topping rubber formulation: 100 parts by mass of NR, 60 parts by mass of N326, 5.0 parts by mass of sulfur, 1.0 part by mass of vulcanization accelerator DZ, and 1.5 parts by mass of cobalt stearate

The obtained unvulcanized rubber compositions, vulcanized rubber compositions, and all-steel tires for trucks and buses were evaluated according to the following. The results are shown in Tables 1 and 2.

(Processability (rubber flow))

In accordance with JIS K6300, the Mooney viscosity ML₍₁₊₄₎ of each unvulcanized rubber composition (rubber piece) at 130° C. was measured . The Mooney viscosity in the range of 56 to 68 is desirable in terms of prevention of rubber flow.

(Viscoelasticity test)

The complex elastic modulus (E*) and loss tangent (tan δ) of each vulcanized rubber composition (the insulation of each all-steel tire for trucks and buses) were measured with a viscoelasticity spectrometer VES (produced by Iwamoto Seisakusho Co., Ltd.) under the conditions of a temperature of 70° C., a frequency of 10 Hz, an initial strain of 10%, and a dynamic strain of 2%. The E* in the range of 7.0 to 8.5 corresponds to an acceptable permanent deformation. Also, a smaller tan S corresponds to better fuel economy.

(Test of adhesion to cords (rubber coverage score after peeling))

Steel cords were covered with each unvulcanized rubber composition (rubber plate), and then press-vulcanized for 35 minutes at 150° C. and 21 kgf/cm². Subsequently, the vulcanized product was subjected to degradation for 150 hours at a temperature of 80° C. and a humidity of 95% to prepare a sample for a peeling test.

An adhesion test was performed on the obtained samples for a peeling test. In the test, the rubber coverage after peeling (the proportion of the area covered with the rubber composition based on the peeled surface area when the rubber composition was peeled off the steel cords) was measured and scored with the rubber coverage of Comparative Example 1 taken as 3 points. A larger score corresponds to better adhesion to steel cords.

(Tensile test)

The elongation at break, EB (%), of a No. 3 dumbbell-shaped test piece prepared from each vulcanized rubber composition (the insulation of each all-steel tire for trucks and buses) was measured in a tensile test at room temperature in accordance with JIS K 6251 “Rubber, vulcanized or thermoplastic—Determination of tensile stress-strain properties.” A larger EB indicates better elongation at break.

(Drum endurance test)

In an overload test under the conditions: an overload of 140% of the maximum load under the JIS standard (JIS center rim, JIS maximum internal pressure), peeling occurs in the buttress or clinch portion, starting from a distorted part of the carcass cords. The initial peeling corresponds to plating layer cracks. The micro cracks spread to the topping layer, and then even to the tie gum layer, and finally a separation occurs.

A drum endurance test was performed on each all-steel tire for trucks and buses. The endurance mileage until a separation between the plies and sidewalls in the buttress portion occurred or a bulge appeared was measured. Each tire was evaluated by an index with the mileage of Comparative Example 1 taken as 100. The mileage until a peeling occurs (=durability; driving until a bulge appearance is observed) is shorter (inferior) when waves at the cords are large, or when the EB of the insulation is low, or when the tan 6 is high, or when the gauge of the tie gum is thick. The mileage (durability) is longer (superior) when waves at the cords are absent, or when the EB of the insulation is large, or when the tan 5 is small, or when the E* is large, or when the insulation has an appropriate thickness (0.6-1 mm).

(Sheet processability) Each formulation was evaluated by an index concerning the following five aspects in the production of an all-steel tire for trucks and buses, with the index of Comparative Example 1 taken as 100. The five aspects are: occurrence of scorch of the extrudate, flatness of the sheet, size retention characteristics of the extrudate (no non-uniform shrinking of the sheet), straightness (no roughness on the edges), and occurrence of sulfur blooms on the sheet surface (adhesion). A larger index corresponds to better sheet processability.

TABLE 1

| | Examples | | | | | | | | | | |
|---|---|---|---|---|---|---|---|---|---|---|---|
| | 1 | 2 | 3 | 4 | 5 | 6 | 7 | 8 | 9 | 10 | 11 |
| NR | 80 | 80 | 80 | 80 | 80 | 80 | 80 | 80 | 80 | 80 | 80 |
| IR | 20 | 20 | 20 | 20 | 20 | 20 | 20 | 20 | 20 | 20 | 20 |
| BR | — | — | — | — | — | — | — | — | — | — | — |
| Butyl rubber | — | — | — | — | — | — | — | — | — | — | — |
| Carbon black (N762, BET27) | — | — | — | — | — | — | — | — | — | — | — |
| Carbon black (N660, BET32) | — | — | — | — | — | — | — | — | — | — | — |
| Carbon black (N550, BET40) | — | — | — | — | — | 20 | — | — | — | — | — |
| Carbon black (N326, BET83) | 50 | 50 | 50 | 50 | 50 | 30 | 50 | 50 | 50 | 50 | 50 |
| Carbon black (N220, BET111) | — | — | — | — | — | — | — | — | — | — | — |
| Silica (VN3, BET175) | 10 | 10 | 10 | 10 | 10 | 10 | 10 | 10 | 10 | 10 | 10 |
| Silica (VN2, BET125) | — | — | — | — | — | — | — | — | — | — | — |
| Silica (U360, BET50) | — | — | — | — | — | — | — | — | — | — | — |
| Silica (Z1085Gr, BET80) | — | — | — | — | — | — | — | — | — | — | — |
| Silica (U9000, BET230) | — | — | — | — | — | — | — | — | — | — | — |
| C5 resin | 2 | 2 | 2 | 2 | 2 | 2 | 2 | 2 | 2 | 2 | 2 |
| TDAE oil | — | — | — | — | — | — | — | — | — | — | — |
| Si 75 | — | — | — | — | — | — | — | — | — | — | — |
| Sumikanol 620 | — | — | — | — | — | — | 1.5 | — | — | — | — |
| Zinc oxide | 8 | 8 | 8 | 8 | 8 | 8 | 8 | 8 | 8 | 8 | 8 |
| Stearic acid | — | — | — | — | 0.5 | — | 0.5 | 0.5 | — | — | — |
| Cobalt boron neodecanoate (Co: 22.5%) | — | — | — | — | 0.29 | — | — | — | — | — | — |
| Cobalt stearate (Co: 9.5%) | 0.7 | 0.7 | 0.7 | 0.7 | — | 0.7 | — | — | — | 0.7 | 0.7 |
| Stearic acid content | 0.63 | 0.63 | 0.63 | 0.63 | 0.50 | 0.63 | 0.50 | 0.50 | 0.00 | 0.63 | 0.63 |
| Antioxidant | 1 | 1 | 1 | 1 | 1 | 1 | 1 | 1 | 1 | 1 | 1 |
| Oil-containing insoluble sulfur | 6.25 | 625 | 6.25 | 6.25 | 6.25 | 6.25 | 625 | 6.25 | 6.25 | 6.25 | 6.25 |
| (Pure sulfur content) | (5.0) | (5.0) | (5.0) | (5.0) | (5.0) | (5.0) | (5.0) | (5.0) | (5.0) | (5.0) | (5.0) |
| Duralink HTS | — | — | — | — | — | — | — | 1 | — | — | — |
| Activator 73A | — | — | — | — | — | — | — | — | 1 | — | — |
| Sumikanol 507A | — | — | — | — | — | — | 1.8 | — | — | — | — |
| Vulcanization accelerator TBBS | — | — | — | — | — | — | — | — | — | 0.8 | — |
| Vulcanization accelerator TBSI | — | — | — | — | — | — | — | — | — | — | 0.8 |
| Vulcanization accelerator DCBS | 0.8 | — | — | — | 0.8 | 0.8 | 0.5 | 0.8 | 0.8 | — | — |
| Rubber flow ML₍₁₊₄₎ at 130° C. | 59 | 59 | 59 | 59 | 61 | 56 | 63 | 61 | 63 | 59 | 60 |
| (Target: 56 to 68) | | | | | | | | | | | |
| Permanent deformation E* at 70° C. | 7.5 | 7.5 | 7.5 | 7.5 | 7.5 | 7.2 | 7.9 | 7.6 | 8 | 82 | 7.8 |
| (Target: 7.0 to 8.5) | | | | | | | | | | | |
| Adhesion to cords (Target: | 4 | 4 | 4 | 4 | 5 | 4 | 3 | 4 | 4 | 3 | 4 |
| not less than 3 points out of 5 points) | | | | | | | | | | | |
| Rolling performance tan δ at 70° C. | 0.128 | 0.128 | 0.128 | 0.128 | 0.128 | 0.114 | 0.131 | 0.125 | 0.126 | 0.119 | 0.124 |
| (Target: <0.13) | | | | | | | | | | | |
| Elongation at break (EB %) (Target: >500) | 570 | 570 | 570 | 570 | 570 | 555 | 600 | 585 | 545 | 520 | 555 |
| Drum endurance index (Target: >100) | 120 | 100 | 135 | 115 | 135 | 115 | 100 | 120 | 120 | 100 | 120 |
| Sheet processability index (Target: >90) | 100 | 90 | 110 | 140 | 100 | 110 | 95 | 95 | 95 | 100 | 100 |
| Sheet thickness of insulation before | 1.0 | 0.6 | 1.5 | 2.0 | 1.0 | 1.0 | 1.0 | 1.0 | 1.0 | 1.0 | 1.0 |
| building (mm) (The thickness of | | | | | | | | | | | |
| insulation built in a tire is about | | | | | | | | | | | |
| 60% to 90% of the sheet thickness) | | | | | | | | | | | |
| | Examples | | | | | | | | | | |
| | 12 | 13 | 14 | 15 | 16 | 17 | 18 | 19 | 20 | 21 | 22 |
| NR | 80 | 80 | 80 | 80 | 80 | 80 | 80 | 80 | 80 | 70 | 80 |
| IR | 20 | 20 | 20 | 20 | 20 | 20 | 20 | 20 | — | 30 | 20 |
| BR | — | — | — | — | — | — | — | — | 20 | — | — |
| Butyl rubber | — | — | — | — | — | — | — | — | — | — | — |
| Carbon black (N762, BET27) | — | — | — | — | — | — | — | — | — | — | — |
| Carbon black (N660, BET32) | — | — | — | — | — | — | — | 20 | — | — | — |
| Carbon black (N550, BET40) | — | — | — | — | — | — | — | — | — | — | 52 |
| Carbon black (N326, BET83) | 50 | 50 | 53 | 40 | 50 | 50 | 50 | 30 | 50 | 40 | — |
| Carbon black (N220, BET111) | — | — | — | — | — | — | — | — | — | — | — |
| Silica (VN3, BET175) | 10 | 10 | 7 | 20 | — | — | — | 10 | 10 | 20 | 15 |
| Silica (VN2, BET125) | — | — | — | — | 10 | — | — | — | — | — | — |
| Silica (U360, BET50) | — | — | — | — | — | — | — | — | — | — | — |
| Silica (Z1085Gr, BET80) | — | — | — | — | — | 10 | — | — | — | — | — |
| Silica (U9000, BET230) | — | — | — | — | — | — | 10 | — | — | — | — |
| C5 resin | 2 | 2 | 2 | 2 | 2 | 2 | 2 | 2 | 2 | — | 2 |
| TDAE oil | — | — | — | — | — | — | — | — | — | — | — |
| Si 75 | — | — | — | 1.2 | — | — | — | — | — | 1.2 | 0.9 |
| Sumikanol 620 | — | — | — | — | — | — | — | — | — | — | — |
| Zinc oxide | 8 | 8 | 8 | 8 | 8 | 8 | 8 | 8 | 8 | 8 | 8 |
| Stearic acid | 0.5 | — | — | — | — | — | — | — | — | 0.5 | — |
| Cobalt boron neodecanoate (Co: 22.5%) | 0.33 | — | — | — | — | — | — | — | — | 0.33 | — |
| Cobalt stearate (Co: 9.5%) | — | 0.7 | 0.7 | 0.7 | 0.7 | 0.7 | 0.7 | 0.7 | 0.7 | — | 0.7 |
| Stearic acid content | 0.50 | 0.63 | 0.63 | 0.63 | 0.63 | 0.63 | 0.63 | 0.63 | 0.63 | 0.50 | 0.63 |
| Antioxidant | 1 | 1 | 1 | 1 | 1 | 1 | 1 | 1 | 1 | 1 | 1 |
| Oil-containing insoluble sulfur | 3.75 | 7 | 6.25 | 6.25 | 6.25 | 6.25 | 6.25 | 6.25 | 6.25 | 6.25 | 6.25 |
| (Pure sulfur content) | (3.0) | (5.6) | (5.0) | (5.0) | (5.0) | (5.0) | (5.0) | (5.0) | (5.0) | (5.0) | (5.0) |
| Duralink HTS | 1 | — | — | — | — | — | — | — | — | — | 1 |
| Activator 73A | — | — | — | — | — | — | — | — | — | — | — |
| Sumikanol 507A | — | — | — | — | — | — | — | — | — | — | — |
| Vulcanization accelerator TBBS | — | — | — | — | — | — | — | — | — | — | — |
| Vulcanization accelerator TBSI | 1 | — | — | — | — | — | — | — | — | — | — |
| Vulcanization accelerator DCBS | — | 0.5 | 0.8 | 0.8 | 0.8 | 0.8 | 0.8 | 0.8 | 0.8 | 0.8 | 0.8 |
| Rubber flow ML₍₁₊₄₎ at 130° C. | 61 | 59 | 57 | 68 | 57 | 56 | 64 | 54 | 61 | 72 | 60 |
| (Target: 56 to 68) | | | | | | | | | | | |
| Permanent deformation E* at 70° C. | 7.4 | 7.6 | 7.6 | 7 | 7.2 | 7 | 7.7 | 7 | 7.7 | 7.1 | 7.1 |
| (Target: 7.0 to 8.5) | | | | | | | | | | | |
| Adhesion to cords (Target: | 3 | 5 | 3+ | 4 | 4 | 3+ | 4 | 4 | 4 | 4 | 5 |
| not less than 3 points out of 5 points) | | | | | | | | | | | |
| Rolling performance tan δ at 70° C. | 0.13 | 0.129 | 0.13 | 0.124 | 0.121 | 0.117 | 0.134 | 0.109 | 0.129 | 0.128 | 0.108 |
| (Target: <0.13) | | | | | | | | | | | |
| Elongation at break (EB %) (Target: >500) | 645 | 555 | 545 | 585 | 550 | 530 | 565 | 525 | 540 | 575 | 595 |
| Drum endurance index (Target: >100) | 140 | 125 | 110 | 125 | 110 | 105 | 120 | 105 | 120 | 130 | 140 |
| Sheet processability index (Target: >90) | 100 | 100 | 100 | 90 | 105 | 110 | 95 | 120 | 110 | 90 | 110 |
| Sheet thickness of insulation before | 1.0 | 1.0 | 1.0 | 1.0 | 1.0 | 1.0 | 1.0 | 1.0 | 1.0 | 1.0 | 1.0 |
| building (mm) (The thickness of | | | | | | | | | | | |
| insulation built in a tire is about | | | | | | | | | | | |
| 60% to 90% of the sheet thickness) | | | | | | | | | | | |

TABLE 2

| | Comparative Examples | | | | | | | | |
|---|---|---|---|---|---|---|---|---|---|
| | 1 | 2 | 3 | 4 | 5 | 6 | 7 | 8 | 9 |
| NR | 80 | 80 | 80 | 80 | 80 | 80 | 80 | 80 | 80 |
| IR | 20 | 20 | 20 | 20 | 20 | 20 | 20 | 20 | 20 |
| BR | — | — | — | — | — | — | — | — | — |
| Butyl rubber | — | — | — | — | — | — | — | — | — |
| Carbon black (N762, BET27) | — | — | — | — | — | — | — | 35 | — |
| Carbon black (N660, BET32) | — | — | — | — | — | — | — | — | — |
| Carbon black (N550, BET40) | — | — | — | — | — | — | — | — | — |
| Carbon black (N326, BET83) | 60 | 60 | 60 | 60 | 57 | 35 | 50 | 20 | 50 |
| Carbon black (N220, BET111) | — | — | — | — | — | — | — | — | — |
| Silica (VN3, BET175) | — | — | — | — | 3 | 25 | — | 10 | 10 |
| Silica (VN2, BET125) | — | — | — | — | — | — | — | — | — |
| Silica (U360, BET50) | — | — | — | — | — | — | 10 | — | — |
| Silica (Z1085Gr, BET80) | — | — | — | — | — | — | — | — | — |
| Silica (U9000, BET230) | — | — | — | — | — | — | — | — | — |
| C5 resin | 2 | 2 | 2 | 2 | 2 | 2 | 2 | 2 | 2 |
| TDAE oil | — | — | — | — | — | — | — | — | — |
| Si 75 | — | — | — | — | — | 1.5 | — | — | — |
| Sumikanol 620 | — | — | — | — | — | — | — | — | — |
| Zinc oxide | 8 | 8 | 8 | 8 | 8 | 8 | 8 | 8 | 8 |
| Stearic acid | — | — | — | — | — | — | — | — | — |
| Cobalt boron neodecanoate (Co: 22.5%) | — | — | — | — | — | — | — | — | — |
| Cobalt stearate (Co: 9.5%) | 0.7 | 0.7 | 0.7 | 0.7 | 0.7 | 0.7 | 0.7 | 0.7 | 1.1 |
| Stearic acid content | 0.63 | 0.63 | 0.63 | 0.63 | 0.63 | 0.63 | 0.63 | 0.63 | 1.00 |
| Antioxidant | 1 | 1 | 1 | 1 | 1 | 1 | 1 | 1 | 1 |
| Oil-containing insoluble sulfur | 6.25 | 6.25 | 6.25 | 6.25 | 6.25 | 6.25 | 6.25 | 6.25 | 6.25 |
| (Pure sulfur content) | (5.0) | (5.0) | (5.0) | (5.0) | (5.0) | (5.0) | (5.0) | (5.0) | (5.0) |
| Duralink HTS | — | — | — | — | — | — | — | — | — |
| Activator 73A | — | — | — | — | — | — | — | — | — |
| Sumikanol 507A | — | — | — | — | — | — | — | — | — |
| Vulcanization accelerator TBBS | — | — | — | — | — | — | — | — | — |
| Vulcanization accelerator TBSI | — | — | — | — | — | — | — | — | — |
| Vulcanization accelerator DCBS | 0.8 | — | — | — | 0.8 | 0.8 | 0.8 | 0.8 | 0.8 |
| Rubber flow ML₍₁₊₄₎ at 130° C. (Target: 56 to 68) | 53 | 53 | 53 | 53 | 53 | 73 | 53 | 49 | 51 |
| Permanent deformation E* at 70° C. | 7.8 | 7.8 | 7.8 | 7.8 | 7.5 | 6.5 | 6.5 | 6.4 | 7.7 |
| (Target: 7.0 to 8.5) | | | | | | | | | |
| Adhesion to cords | 3 | 3 | 3 | 3 | 3 | 4 | 3 | 3 | 4 |
| (Target: not less than 3 points out of 5 points) | | | | | | | | | |
| Rolling performance tan δ at 70° C. | 0.138 | 0.138 | 0.138 | 0.138 | 0.136 | 0.12 | 0.117 | 0.102 | 0.125 |
| (Target: <0.13) | | | | | | | | | |
| Elongation at break (EB %) (Target: >500) | 505 | 505 | 505 | 505 | 515 | 615 | 505 | 475 | 550 |
| Drum endurance index (Target: >100) | 100 | 80 | 115 | 95 | 100 | 120 | 100 | 85 | 100 |
| Sheet processability index (Target: >90) | 100 | 90 | 110 | 135 | 100 | 60 | 100 | 115 | 100 |
| Sheet thickness of insulation before building | 1.0 | 0.6 | 1.5 | 2.0 | 1.0 | 1.0 | 1.0 | 1.0 | 1.0 |
| (mm) (The thickness of insulation built in a tire | | | | | | | | | |
| is about 60% to 90% of the sheet thickness) | | | | | | | | | |
| | Comparative Examples | | | | | | | | |
| | 10 | 11 | 12 | 13 | 14 | 15 | 16 | 17 | 18 |
| NR | 80 | 80 | 80 | 100 | 70 | 80 | 80 | 80 | 80 |
| IR | 20 | 20 | 20 | — | — | 20 | 20 | 20 | 20 |
| BR | — | — | — | — | — | — | — | — | — |
| Butyl rubber | — | — | — | — | 30 | — | — | — | — |
| Carbon black (N762, BET27) | — | — | — | — | — | — | — | — | — |
| Carbon black (N660, BET32) | — | — | — | — | — | — | — | — | — |
| Carbon black (N550, BET40) | — | — | — | — | — | — | — | — | — |
| Carbon black (N326, BET83) | 50 | 50 | 50 | 60 | 50 | 60 | — | — | 50 |
| Carbon black (N220, BET111) | — | — | — | — | — | — | 50 | 45 | — |
| Silica (VN3, BET175) | 10 | 10 | 10 | — | 10 | — | 10 | — | 10 |
| Silica (VN2, BET125) | — | — | — | — | — | — | — | — | — |
| Silica (U360, BET50) | — | — | — | — | — | — | — | — | — |
| Silica (Z1085Gr, BET80) | — | — | — | — | — | — | — | — | — |
| Silica (U9000, BET230) | — | — | — | — | — | — | — | — | — |
| C5 resin | 2 | 2 | 2 | 2 | 2 | — | 2 | 2 | 2 |
| TDAE oil | — | — | — | — | — | 2 | — | — | — |
| Si 75 | — | — | — | — | — | — | — | — | — |
| Sumikanol 620 | — | — | — | — | — | — | — | — | — |
| Zinc oxide | 8 | 8 | 8 | 8 | 8 | 8 | 8 | 8 | 8 |
| Stearic acid | — | 0.5 | 0.5 | 0.5 | — | 1 | — | — | — |
| Cobalt boron neodecanoate (Co: 22.5%) | — | 0.33 | 0.33 | 0.33 | — | — | — | — | — |
| Cobalt stearate (Co: 9.5%) | 2 | — | — | — | 0.7 | 0.7 | 0.7 | 0.7 | 0.7 |
| Stearic acid content | 1.81 | 0.50 | 0.50 | 0.50 | 0.63 | 1.63 | 0.63 | 0.63 | 0.63 |
| Antioxidant | 1 | 1 | 1 | 1 | 1 | 1 | 1 | 1 | 1 |
| Oil-containing insoluble sulfur | 6.25 | 3.13 | 3.13 | 6.25 | 3.13 | 6.25 | 6.25 | 6.25 | 7.5 |
| (Pure sulfur content) | (5.0) | (2.5) | (2.5) | (5.0) | (2.5) | (5.0) | (5.0) | (5.0) | (6.0) |
| Duralink HTS | — | 1 | 1 | — | — | — | — | — | — |
| Activator 73A | — | — | — | — | — | — | — | — | — |
| Sumikanol 507A | — | — | — | — | — | — | — | — | — |
| Vulcanization accelerator TBBS | — | — | — | — | — | — | — | — | — |
| Vulcanization accelerator TBSI | — | 1.2 | 1.2 | — | 1.2 | — | — | — | — |
| Vulcanization accelerator DCBS | 0.8 | — | — | 0.3 | — | 0.8 | — | — | 0.5 |
| Rubber flow ML₍₁₊₄₎ at 130° C. (Target: 56 to 68) | 48 | 61 | 61 | 61 | 52 | 45 | 74 | 52 | 59 |
| Permanent deformation E* at 70° C. | 7.9 | 6.8 | 6.8 | 7.8 | 6.2 | 8.2 | 9.8 | 7.7 | 7.6 |
| (Target: 7.0 to 8.5) | | | | | | | | | |
| Adhesion to cords | 4 | 1 | 1 | 3 | 1 | 2 | 4 | 3 | 4 |
| (Target: not less than 3 points out of 5 points) | | | | | | | | | |
| Rolling performance tan δ at 70° C. | 0.122 | 0.13 | 0.13 | 0.14 | 0.159 | 0.134 | 0.168 | 0.149 | 0.131 |
| (Target: <0.13) | | | | | | | | | |
| Elongation at break (EB %) (Target: >500) | 530 | 640 | 640 | 525 | 585 | 465 | 595 | 490 | 550 |
| Drum endurance index (Target: >100) | 85 | 100 | 80 | 120 | 70 | 70 | 80 | 90 | 95 |
| Sheet processability index (Target: >90) | 115 | 135 | 115 | 80 | 100 | 120 | 60 | 95 | 60 |
| Sheet thickness of insulation before building | 1.0 | 1.5 | 1.0 | 1.0 | 1.0 | 1.0 | 1.0 | 1.0 | 1.0 |
| (mm) (The thickness of insulation built in a tire | | | | | | | | | |
| is about 60% to 90% of the sheet thickness) | | | | | | | | | |

As shown in Tables 1 and 2, in Examples 1 to 4 in which the wet silica was used, favorable rubber viscosity was achieved, compared with Comparative Examples 1 to 4 in which the wet silica was not used. Accordingly, it has been shown in the Examples that rubber flow can be controlled, which prevents a crack and a separation. Also, the adhesion to cords, elongation at break, drum endurance, and sheet processability were greatly improved. In Example 5 in which cobalt boron neodecanoate was used, the adhesion was particularly excellent. In Examples 7 to 9 in which Duralink HTS, Activator 73A, and Sumikanol 507A were used, the effect of increasing the viscosity was exerted. In Example 10 in which the vulcanization accelerator TBBS was used, acceptable adhesion was achieved. In Example 11 in which the vulcanization accelerator TBSI was used, excellent adhesion was achieved.

In Example 22 in which Duralink HTS was further added to a formulation including carbon black N550 and silica, both the E* and the adhesion were improved, and the elongation at break, sheet processability, and rolling performance were also fine. In Comparative Example 16 in which the carbon black N 220 and silica were used, the heat build-up was high and the durability was deteriorated, and poor sheet processability was also observed. In Comparative Example 17 in which N220 was used, poor elongation at break and poor rolling performance were observed. In Comparative Example 18 in which the pure sulfur content was 6.0 parts and 0.5 parts of the vulcanization accelerator DCBS was used, poor sheet processability was observed because of sulfur blooms. Also, large thermo-oxidative degradation and therefore poor durability were observed.

REFERENCE SIGNS LIST

1: All-steel tire (pneumatic tire)

2: Tread portion

3: Sidewall rubber

4: Bead portion

5: Bead apex

6: Carcass

6a: Carcass cord

7: Belt layers

8: Bead core

9: Inner liner

9b: Inner liner rubber

10: Insulation rubber

11: Waves

12: Crack, Separation

13: Thickness of insulation rubber (at a tire maximum width position)

1. A tire with steel belts and a steel carcass which comprises an insulation produced from a rubber composition, the rubber composition comprising:
a diene rubber,
a wet silica with a BET specific surface area of 70 to 250 m²/g,
a carbon black with a BET specific surface area of 30 to 90 m²/g, and
sulfur,
an amount of the wet silica being 7 to 20 parts by mass,
an amount of the carbon black being 30 to 60 parts by mass,
an amount of the sulfur being 3.0 to 5.6 parts by mass, and
an amount of an organic acid cobalt being not more than 0.08 parts by mass in terms of cobalt,
all for each 100 parts by mass of the diene rubber.

2. The tire with steel belts and a steel carcass according to claim 1,
wherein the rubber composition has a Mooney viscosity ML₍₁₊₄₎ of 54 to 72 at 130° C. when the rubber composition is at an initial stage of vulcanization.

3. The tire with steel belts and a steel carcass according to claim 1,
wherein the rubber composition comprises a vulcanization accelerator,
the amount of the carbon black with a BET specific surface area of 30 to 90 m²/g is 40 to 55 parts by mass, and
an amount of the vulcanization accelerator is 0.7 to 2.0 parts by mass,
all for each 100 parts by mass of the diene rubber.
